(19) United States
(12) Patent Application Publication
(10) Pub. No.: US 2026/0073027 A1
(43) Pub. Date: Mar. 12, 2026

(54) Using Codes to Track Ownership of Documents

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); Steven M. Cohen, DELRAY BEACH, FL (US)

(73) Assignee: MICRO FOCUS LLC, WILMINGTON, DE (US)

(21) Appl. No.: 18/883,657

(22) Filed: Sep. 12, 2024

(51) Int. Cl. G06F 21/16; G06F 21/31

(52) U.S. Cl. CPC G06F 21/16; G06F 21/31

(57) ABSTRACT

A first redirect request is received. The first redirect request is based on a link to a document server in a first code embedded in a document. For example, the first code embedded in the document may be a QR code. A user is authenticated. The user has an interest right in the document. The interest right may be an ownership right to the document. A request to change the interest right in the document is received. In response to receiving the request to change the interest right in the document, a second code is generated based on the change in interest right in the document. The second code is embedded into a copy of the document. The copy of the document with the embedded second code is sent. For example, the copy of the document with the embedded second code is sent to a new owner of the document.

### FIELD

The disclosure relates generally to tracking rights associated with documents and particularly to tracking rights associated with documents using codes.

### BACKGROUND

Being able to track licensing, chain of title, media rights, and ownership, of a document (e.g., a video, an image, etc.) is difficult. In addition, identifying illegitimate copies of the document is difficult. One way to deal with these problems is to use watermarks or steganographic tags. While watermarks, or steganographic tags, provide some protection in identifying documents, they still have issues and are difficult to track in documents.

### SUMMARY

These and other needs are addressed by the various embodiments and configurations of the present disclosure. The present disclosure can provide a number of advantages depending on the particular configuration. These and other advantages will be apparent from the disclosure contained herein.

A first redirect request is received. The first redirect request is based on a link to a document server in a first code embedded in a document. For example, the first code embedded in the document may be a Quick Response (QR) code. A user is authenticated. The user has an interest right in the document. An interest right may be an ownership right to the document. A request to change the interest right in the document is received. In response to receiving the request to change the interest right in the document, a second code is generated based on the change in interest right in the document. The second code is embedded into a copy of the document. The copy of the document with the embedded second code is sent. For example, the copy of the document with the embedded second code is sent to a new owner of the document.

The phrases "at least one", "one or more", “or,” and "and/or" are open-ended expressions that are both conjunctive and disjunctive in operation. For example, each of the expressions "at least one of A, B and C", "at least one of A, B, or C", "one or more of A, B, and C", "one or more of A, B, or C", "A, B, and/or C", and "A, B, or C" means A alone, B alone, C alone, A and B together, A and C together, B and C together, or A, B and C together.

The term "a" or "an" entity refers to one or more of that entity. As such, the terms "a" (or "an"), "one or more" and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As defined herein, the term “document” may include any type of document/file, such as a text document (e.g., a Word document, a PDF, etc.), an image, a video, an audio recording, a spreadsheet, a presentation, an email, a voicemail, information in a database, files in a file system, source code, a Non-Fungible Token (NFT), a webpage, a website, and/or the like. In other words, a document may include any type of information that can be electronically stored.

As defined herein, the term “interest right” comprises any right associated with the use of the document, such as an ownership right, a time of use right, a copyright, a sell right, a public performance right, a number of copies right, a license, a derivative works right, a display right, a right to use in a training set of an AI algorithm, and/or the like. An interest right may have various types of information associated with the interest right, such as a creator, a creation date, a license, an ability to sale field, a number of sales, a use in a training set field, a use in a specific type of training set field, a time of use field, a derivate works field, a display right field, a public performance right field, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using a code to track interest rights associated with a document.

FIG. 2 is a diagram of a text document with a code.

FIG. 3 is a diagram of a code used to track interest rights associated with a document.

FIG. 4 is a flow diagram of a process defining interest right(s) for documents that are going to be purchased and/or licensed.

FIG. 5 is a flow diagram of a process for changing interest right(s) in a document.

FIG. 6 is a flow diagram of a process for determining current interest right(s) in a document.

FIG. 7 is a diagram of a code used to track interest right(s) associated with a document using a code validator.

FIG. 8 is a flow diagram of a process for using a code validator and a document server to track interest rights associated with a document.

FIG. 9 is a diagram of a blockchain that is used to track interest rights associated with a document.

FIG. 10 is a diagram of a star blockchain that is used to track interest rights associated with multiple copies of a document.

FIG. 11 is a flow diagram of a process for scraping web sites with documents that have interest rights that are used to train an Artificial Intelligence (AI) algorithm.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

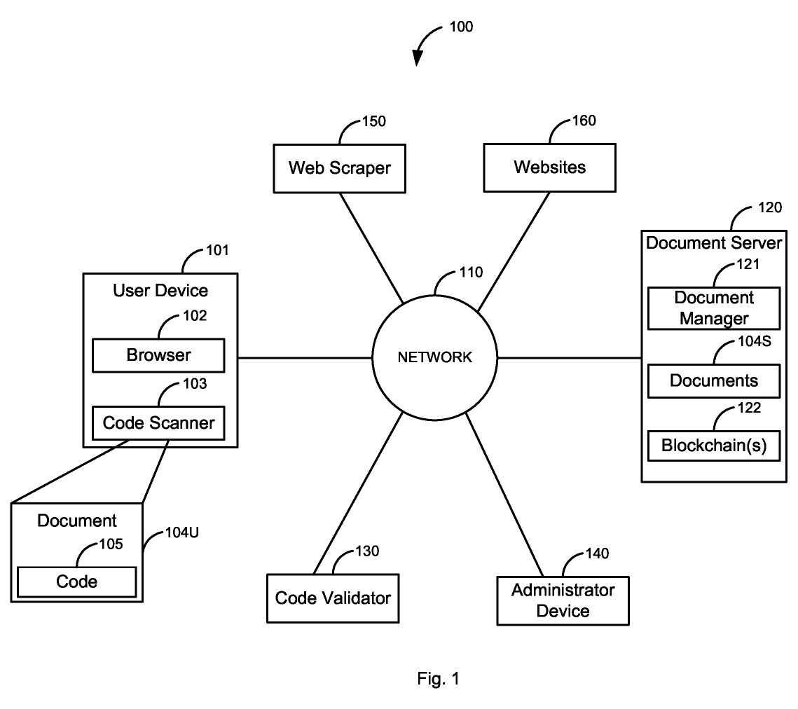

FIG. 1 is a block diagram of a first illustrative system 100 for using a code 105 to track interest rights associated with a document 104. The first illustrative system 100 comprises a user device 101, a document 104U, a document server 120, a code validator 130, an administrator device 140, a web scraper 150, and websites 160.

The user device 101 can be or may include any user device 101 that can communicate on the network 110, such as a Personal Computer (PC), a cellular telephone, a Personal Digital Assistant (PDA), a tablet device, a laptop computer, a notebook device, a smartphone, and/or the like. Although FIG. 1 only shows a single user device 101, there may be any number of user devices 101 connected to the network 110.

The user device 101 further comprises a browser 102 and a code scanner 103. The browser 102 may be any type of browser 102, such as a Google Crome ® browser, A Mozilla Firefox® browser, a Microsoft Edge® browser, an Opera browser, a Safari browser, a Lynx browser, and/or the like. The browser 102 may be used to access the websites 160 and/or the document server 120.

The code scanner 103 is used to scan codes 105 in the document 104U. The code scanner 103 may be a camera, a QR code scanner, a barcode scanner, a color QR code scanner, and/or the like.

The code 105 in the document 104U may comprise various kinds of codes 105, such as a Quick Response (QR) code 105, a color QR code 105, a barcode 105, and/or the like.

The document 104U may be any type of user document/file that contains digital information, such as a text document, an image, a video, an audio recording, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The document server 120 is used to manage interest rights associated with the documents 104. The document server 120 comprises a document manager 121, documents 104S, and blockchain(s) 122.

The document manager 121 manages the interest rights associated with the documents 104S. The document manager 121 manages the use and generation of the codes 105 for use in tracking the interest rights associated with the documents 104S.

The documents 104S are various documents 104 that have associated interest rights. The documents 104S may include different types of documents 104, such as text documents, images, videos, and/or the like. The documents 104S may also have an associated code 105.

The blockchain(s) 122 are used to track the interest rights associated with the documents 104S. The blockchain(s) 122 may track different types of information associated with the interest rights.

The code validator 130 is a service that allows different parties (e.g., different companies) to use the document server 120. The code validator 130 may validate the codes 105 using a signed certificate.

The administrator device 140 can be or may include any device that allows a user to administer the document server 120, such as a personal computer, a laptop computer, a smartphone, and/or the like.

The web scraper 150 is used to scrape documents 104 from the websites 160. The web scraper 150 may be used to scrap documents 104 from the websites 160 to get training set data for Artificial Intelligence (AI) algorithms or for other reasons, such as document repositories, information collection, search engines, and/or the like.

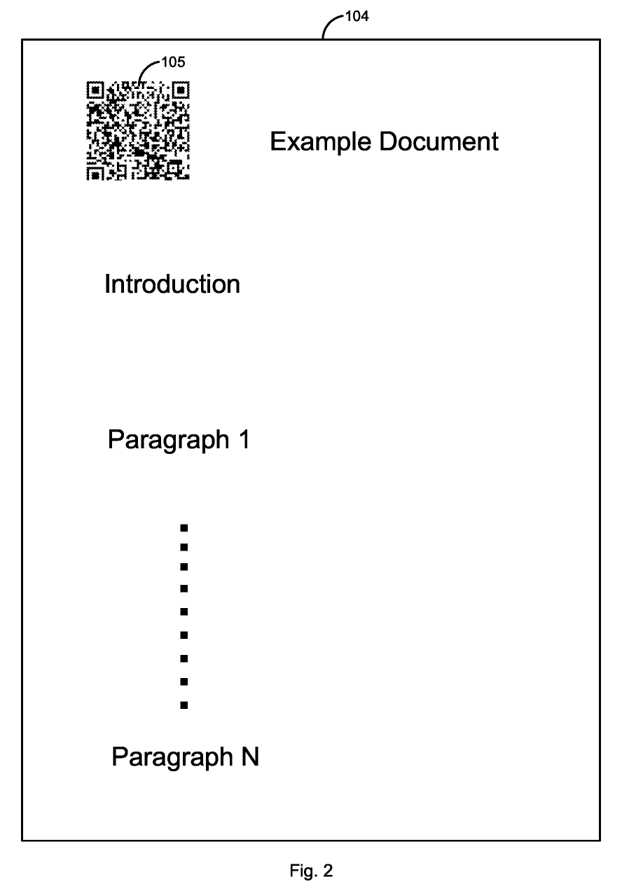

FIG. 2 is a diagram of a text document 104 with a code 105. In FIG. 2, the code 105 in the example document 104 is a Quick Response (QR) code 105. The code 105 is used to not only track the interest rights associated with the document 104, but also individual copies of the document 104.

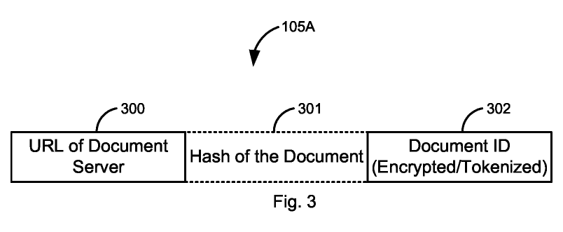

FIG. 3 is a diagram of a code 105A used to track interest rights associated with a document 104. The code 105A is embedded into the document 104 when the document 104 is first purchased/licensed. An example of the information that is in the code 105A is shown in FIG. 3.

The code 105 includes a Uniform Resource Locator (URL) of a document server 300, an optional hash of the document 301, and a document identifier 302. The URL of the document server 300 is used to redirect the user to the document server 120 that manages the interest rights for the document 104.

The hash of the document 301 is a hash of the document 104. The hash of the document 301 covers the document 104 along the code 105A embedded in the document 104. The hash of the document 301 is used to validate that the document 104 and/or the code 105A has not been altered or corrupted. The hash of the document 104 may use various hashing algorithms. The code 105A may include additional information such as a hash of characters in the document 104, security information (e.g., a signed certificate), and/or the like. In one embodiment, the different segments of the code 105A may use different color ranges. For example, the hash of the document 301 may be based on specific colors and the document identifier 302 may use different colors in different positions in the code 105A.

The document identifier 302 (which may be encrypted or tokenized) is a unique identifier associated with the document 104. The size of the document identifier 302 may vary based on implementation. For example, the size of document identifier 302 may be 32 bits, in one implementation and 64 bits in another implementation. Based on the document identifier 302, information associated with the document’s current state can be identified, such as the current owner, a current associated license, a current grant of interest rights for the document 104, a chain of title associated with the document 104, and/or the like. If the document 104 has multiple licensed copies with different owners, different interest rights, difference licenses, different chains of title and/or the like, there will be a different document identifier 302 associated with that instance of the document 104.

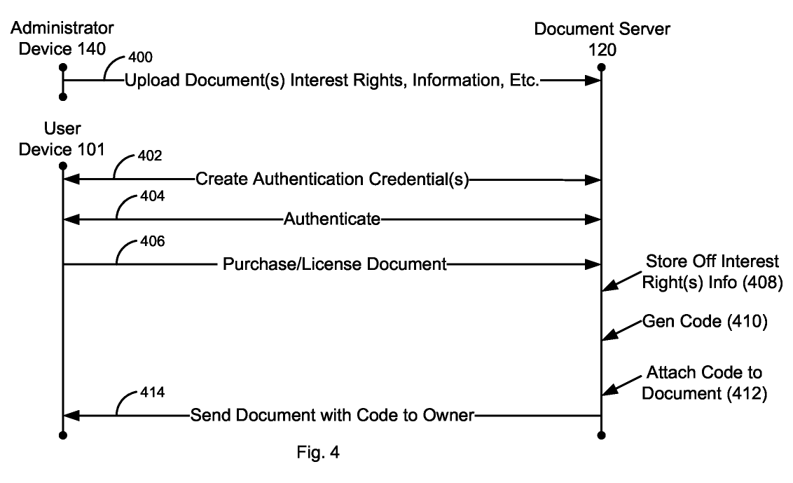

FIG. 4 is a flow diagram of a process defining interest right(s) for documents 104 that are going to be purchased and/or licensed. Illustratively, the user device 101, the browser 102, the code scanner 103, the document server 120, the document manager 121, the code validator 130, the administrator device 140, the web scraper 150, and the websites 160 are stored-program-controlled entities, such as a computer or microprocessor, which performs the method of FIGS. 4-6, 8, and 11 and the processes described herein by executing program instructions stored in a computer readable storage medium, such as a memory (i.e., a computer memory, a hard disk, and/or the like). Although the methods described in FIGS. 4-6, 8, and 11 are shown in a specific order, one of skill in the art would recognize that the steps in FIGS. 4-6, 8, and 11 may be implemented in different orders and/or be implemented in a multi-threaded environment. Moreover, various steps may be omitted or added based on implementation.

FIG. 4 shows how an individual document 104 is added to the document server 120 and then purchased/licensed. In step 400, an administrator uploads the document(s) 104 from the administrator device 140. In addition, the administrator defines what interest rights are associated with the document(s) 104 and other information associated with the interest rights. The interest rights of step 400 may include an original owner. The license information may describe how the user can use the document 104 or other license information, such as open-source licensing information. The interest rights may include information about how document 104 may be copied, used in public, if derivative works may be created, and/or the like.

For example, the administrator may define that there are 100 instances of movie X that are going to be available to purchase. Of the 100 instances of the movie X, 50 are in HD and 50 are in Ultra HD. Of the 50 that are in HD, 40 can be sold to another user and 10 cannot be resold. Of the 50 that are in Ultra HD, 5 have public display rights where the other 45 do not. For each of the 100 instances of the movie X, there will be a unique document identifier 302 associated with each instance. In addition, as the interest rights associated with each instance of the document 104 changes, the document identifier 302 will change to new unique document identifier 302.

To purchase/license the document 104 in step 402, the user creates authentication credentials (e.g., a username/password) and then authenticates in step 404. Once authenticated, the user then purchases/licenses a document(s) 104 in step 406. For example, the user may request to license one of the 40 HD movies that can be resold to another user. In response, the license information, interest rights information are stored off in step 408. In addition, a chain of title may be started. The chain of title would have the original owner/creator and the new owner who just purchased/licensed the document 104. A code 105 is generated in step 410 (or may have been previously generated when the document 104 was uploaded) and the code 105 is then attached/embedded into the document 104 in step 412. Although not shown, the code 105 may be stored.

The embedding may occur in various ways. For example, if the document 104 is an audio file, a wrapper (source code for displaying the code 105) for the audio file may be used. If the document 104 is an image, the image may have a code page and then the image page or the code 105 may be placed in an area of the image (e.g., as shown in FIG. 2). In documents 104 like PDFs, the image may be placed in a new page or in a blank area in the first page (or any page) of the document 104. In a Word document, the code 105 can be added as a code page, added as a footer, placed in an area of the Word document, etc. The document 104 with the code 105 is then sent to the new owner in step 414.

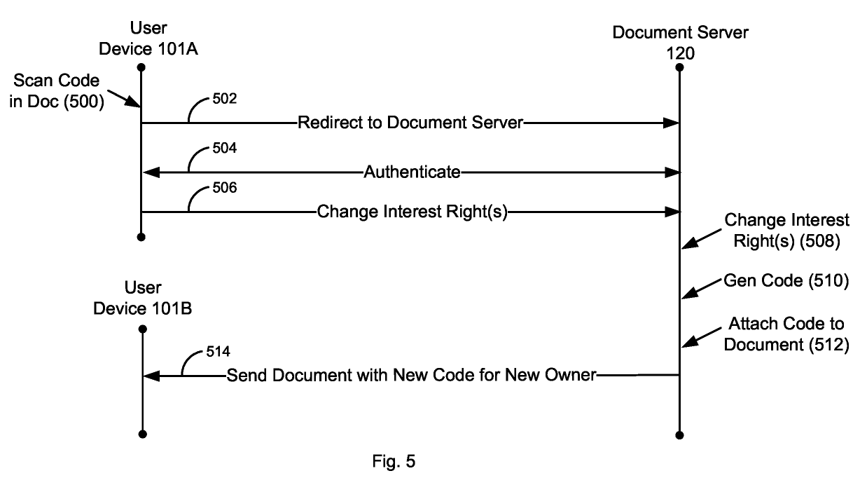

FIG. 5 is a flow diagram of a process for changing interest right(s) in a document 104. Once the user has purchased/licensed the document 104, the user may sell/change ownership and/or change interest rights of the document 104 as shown in FIG. 5.

The user can either scan the code 105 at the user device 101A in step 500, get redirected to the document server 120 in step 502, and authenticate in step 504, or directly authenticate in step 504 via the user device 101A. Once authenticated, the user can then change the ownership of the document(s) 104/interest rights (if the user has permissions to do so) in step 506. For example, the user (user A) may transfer the document 104 to user B. In addition, the user may have to option to change specific interest rights. For example, if the license allows for unlimited reselling, the user may change the interest rights to not allow any reselling of the document 104 purchased by user B (or this could occur automatically).

Once the user has changed the ownership/interest rights in step 506, the interest rights are changed in step 508. In addition, the chain of title will be changed to now include user B in the chain of title and show that user B is now the current owner. A new code 105 is generated (with the new document identifier 302/hash of the document 301) in step 510 and then attached/embedded into the document 104 in step 512. The new code may also be stored. The new code 105 is associated with the new owner and has a new document identifier 302. Thus, if the previous owner keeps an unlicensed copy with the previous document identifier 302, the unlicensed copy of the document 104 can be identified as being illegitimate. The document 104 with the new code 105 is then sent to the new owner at the user device 101B in step 514. In addition, there may be a message sent that tells the previous owner at the user device 101A to delete any copies of the document 104 with the old document identifier 302.

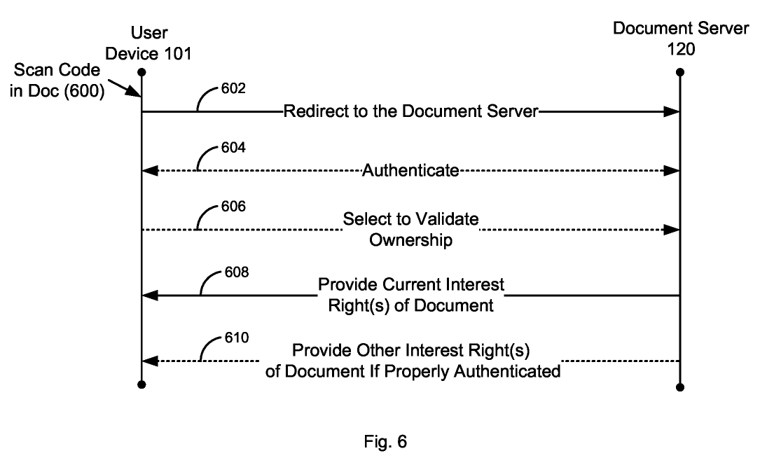

FIG. 6 is a flow diagram of a process for determining current interest right(s) in a document 104. The user scans the code 105 in the document 104 in step 600, which redirects the user to the document server 120 in step 602. The user may optionally authenticate in step 604 and select to validate in step 606. Validating means to determine specific ownership/interest rights. The document server 120 provides the current interest rights of the document 104 in step 608. Step 608 may be based on a specific user’s rights. For example, the original owner/issuer of the document 104 may be able to see the full chain of title based or an individual past right of an by owner properly authenticating (may require a specific authentication level). The document server 120 may provide other interest rights of the document 104 based on the user’s authentication level in step 610.

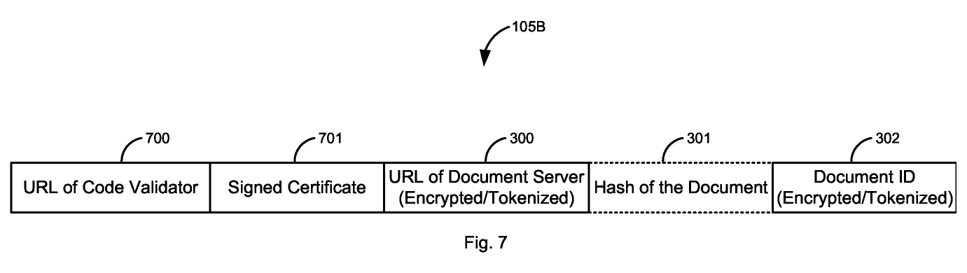

FIG. 7 is a diagram of a code 105B used to track interest right(s) associated with a document 104 using a code validator 130. The code validator 130 is a service that is used to validate codes 105. When the code validator 130 is used, the code 105 contains additional information as shown in FIG. 7. The code 105B of FIG. 7 includes the additional fields of the URL of the code validator 700 and a signed certificate 701 along with the URL of the document server 300, the optional hash of the document 301, and the document identifier 302. The URL of the code validator 700 is used to redirect to the code validator 130. The signed certificate 701 is used to validate that the code 105B is legitimate.

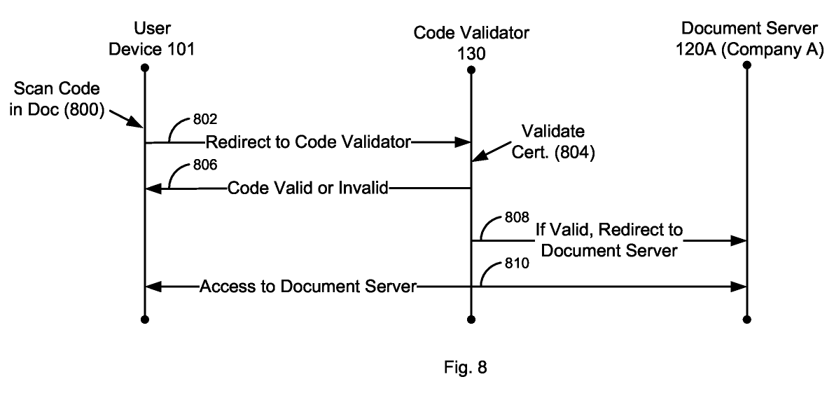

FIG. 8 is a flow diagram of a process for using a code validator 130 and a document server 120 to track interest rights associated with a document 104. When the code 105B is scanned in step 800, instead of being redirected to the document server 120 like described in FIG. 5, the user is redirected to the URL of the code validator 700 in step 802. The code validator 130 is a service for validating the authenticity of the code 105B by verifying the signed certificate 701 in the code 105B. The code validator 130 validates the signed certificate 701 in the code 105B in step 804. The signed certificate 701 may be a Private Key Infrastructure (PKI) certificate that is validated, by the code validator 130, using a private key. The code validator 130 sends a message, in step 806, to the user device 101 indicating that the code 105B is either valid or invalid based on a determination that the signed certificate 701 is valid/invalid. If the signed certificate 701 is valid in step 806, the code validator 130 redirects the user to the document server 120 using the URL of the document server 300 (e.g., after unencrypting or untokenizing the URL of the document server 300 if necessary) of the entity (e.g., a company) associated with the code 105B in step 808. The user can then access the document server 120 in step 810. For example, the user may want to change one or more of the interest rights as described in step 506 of FIG. 5.

In one embodiment, the code 105B of FIG. 8 may not have the URL of the document server 300. Instead, the code 105B may have an entity identifier. Based on the entity identifier, the code validator 130 can look up the URL of the document server 300 in order to redirect to the document server 120 in step 808.

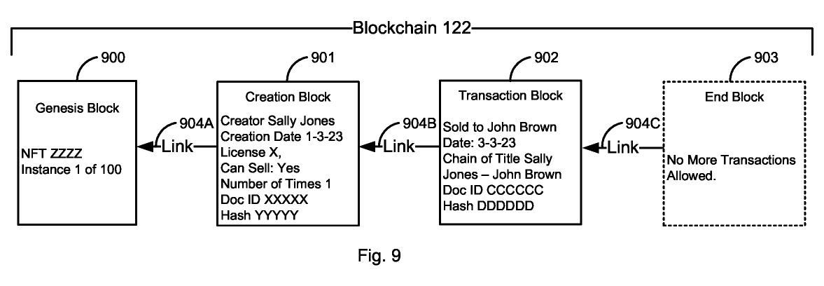

FIG. 9 is a diagram of a blockchain 122 that is used to track interest rights associated with a document 104. When a transaction has occurred (e.g., the document 104 is generated and N copies are made available), each instance of the document 104 can be tracked in a blockchain 122 or database. As there are different transactions associated with each of the instances of the document 104 each transaction can be stored as a block 902 in the blockchain 122. For example, using the example above where there are 100 instances, there may be a separate blockchain 122 created for each instance (i.e., 100 individual blockchains 122). FIG. 9 shows an example of a blockchain 122 that can be used to track one instance. In FIG. 9, the blockchain 122 comprises a genesis block 900, a creation block 901, a transaction block 902, and an optional end block 903.

The genesis block 900 is the first block in the blockchain 122. The genesis block 900 identifies the document 104 (a Non-Fungible Token) ZZZZ and that the blockchain 122 is for instance 1 of 100 of the NFT ZZZZ. The creation block 901 shows that Sally Jones is the creator of the NFT ZZZZ. The NFT ZZZZ is governed by license X. This instance of NFT ZZZZ can be sold 1 time. The original copy of the NFT ZZZZ has a document identifier 302 of XXXXX and a hash of YYYYY. The transaction block 902 indicates that new copy of the NFT ZZZZ was sold to John Brown, has a chain of title of: Sally Jones – John Brown, a document identifier 302 of CCCCCC, and a hash of DDDDDD. In addition, the blockchain 122 may optionally have an end block 903 because this instance cannot be resold, and no more transactions are allowed.

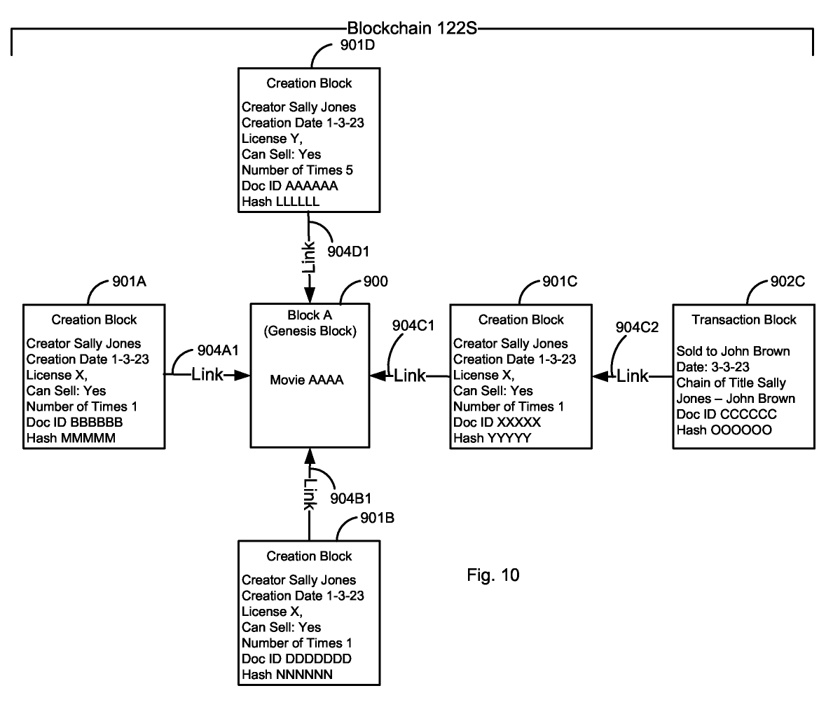

FIG. 10 is a diagram of a star blockchain 122S that is used to track interest rights associated with multiple copies of a document 104. In FIG. 10, there are four instances of the movie AAAA. Each of the four instances form a branch from the genesis block 900. There are four creation blocks 901A-901D that link back to the genesis block 900 via links 904A1-904D1, one for each instance/copy. There are three creation blocks 901A-901C that are licensed under license X and one creation block 901D that is licensed under license Y. There is one creation block 901C that has an associated transaction block 902C. The transaction block 902C links back to the creation block 901C via link 904C2. The transaction block 902C has a chain of title because it was sold to John Brown in addition to having a new document identifier 302 (CCCCCC) and hash (OOOOOO).

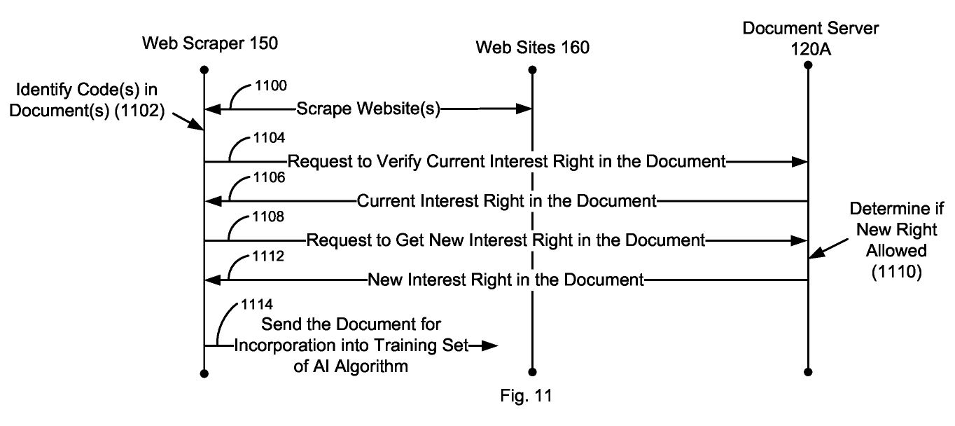

FIG. 11 is a flow diagram of a process for scraping web sites 160 with documents 104 that have interest rights that are used to train an Artificial Intelligence (AI) algorithm. The web scraper 150 scrapes the websites 160 for documents 104 in step 1100. The web scraper 150 (or some other service) identifies the code(s) 105 in the documents 104 in step 1102. The web scraper 150 (or some other service) requests to verify the current interest rights in the document 104, in step 1104, using the code 105 found in the document 104. The web scraper 150 (or some other service) gets the current interest right in step 1106.

If the web scraper 150 wants to use the document 104 as part of a training set of an AI algorithm (or for some other purpose, such as to build a document repository), the web scraper 150 may request a new interest right to use the document 104 in step 1108. For example, the web scraper 150 may request to get a right to use the document 104 in a training set of an AI algorithm. The document server 120A determines, in step 1110 if the new interest right is allowed. If allowed, the web scraper 150 (or some other service) gets the new interest right in step 1112. The web scraper 150 send the document 104 to be incorporated into the training set of the AI algorithm in step 1114 (or for another purpose).

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A document server comprising:
a microprocessor; and
a computer readable medium, coupled with the microprocessor and comprising microprocessor readable and executable instructions that, when executed by the microprocessor, cause the microprocessor to:
receive a first redirect request, wherein the first redirect request is based on a link to the document server in a first code embedded in a document;
authenticate a user, wherein the user has an interest right in the document;
receive a request to change the interest right in the document;
in response to receiving the request to change the interest right in the document, generate a second code based on the change in interest right in the document;
embed the second code into a copy of the document; and
send the copy of the document with the embedded second code.

2. The document server of claim 1, wherein the microprocessor readable and executable instructions further comprise instructions to:
receive a request to verify a current interest right in the document, a past interest right in the document, or a chain of title of the document, wherein the received request to verify the current interest right in the document, the past interest right in the document, or the chain of title of the document is generated based on a scan of the embedded second code in the copy of the document; and
provide the current interest right in the document, the past interest right in the document or the chain of title of the document.

3. The document server of claim 1, further comprising a code validator, wherein first code comprises a link to the code validator and a signed certificate and wherein the code validator:
receives a second redirect request, wherein the second redirect request is based on the link to the code validator in the first code;
validates the second redirect request, wherein second redirect request is validated based on the signed certificate in the first code; and
in response to validating the signed certificate in the first code generate the first redirect request; and
send the first redirect request to the document server.

4. The code validator of claim 3, wherein the link to the document server is encrypted, tokenized, or looked up based on an entity identifier and wherein the code validator unencrypts, untokenizes, or looks up the link to the document server in first redirected request to the document server.

5. The document server of claim 1, wherein the interest right in the document and the changed interest right in the document are stored in a blockchain.

6. The document server of claim 5, wherein the interest right in the document is stored in a creation block in the blockchain.

7. The document server of claim 5, wherein the changed interest right in the document stored in the blockchain cannot be changed again and wherein the microprocessor readable and executable instructions further cause the microprocessor to:
create a transaction block, wherein the transaction block comprises the changed interest right in the document; and
create an end block, wherein the end block is a last block in the blockchain and wherein the end block indicates that the interest right cannot be changed anymore.

8. The document server of claim 1, wherein the microprocessor readable and executable instructions further comprise instructions to:
receive the document and the interest right in the document, wherein the interest right in the document comprises a plurality of individual interest rights for a plurality of individual copies of the document;
in response to receiving the plurality of individual interest rights for the plurality of individual copies of the document, create a star blockchain, wherein the star blockchain comprises a plurality of branches from a genesis block and wherein the plurality of branches are created based on the plurality of individual copies of the document.

9. The document server of claim 8, wherein the plurality of individual interest rights are stored in a plurality of individual creation blocks in the plurality of branches from the genesis block.

10. The document server of claim 1, wherein the change in interest right in the document comprises changing of at least one of: an ownership right, a time of use right, a copy right, a sell right, a public performance right, a number of copies right, a license, a derivative works right, a display right, and a right to use in a training set of an AI algorithm.

11. The document server of claim 1, wherein the readable and executable instructions further cause the microprocessor to:
receive a request to verify a current interest right in the document based on the first code in the document;
send the current interest right in the document;
receive a request to get a new interest right in the document, wherein the new interest right is the right to use the document in a training set of an Artificial Intelligence (AI) algorithm; and
send a response the provides the new interest right in the document.

12. The document server of claim 11, wherein the received request to verify the current interest right in the document is sent based on a web scraper identifying the first code embedded in the document.

13. The document server of claim 1, wherein the first code comprises a Uniform Resource Locator (URL) of the document server and a document identifier and wherein the Uniform Resource Locator (URL) of the document server uses a first color range in the first code and the document identifier uses a second color range in the first code.

14. A method comprising:
receiving, by a microprocessor, a first redirect request, wherein the first redirect request is based on a link to the document server in a first code embedded in a document;
authenticating, by the microprocessor, a user, wherein the user has an interest right in the document;
receiving, by the microprocessor, a request to change the interest right in the document;
in response to receiving the request to change the interest right in the document, generating, by the microprocessor, a second code based on the change in interest right in the document;
embedding, by the microprocessor, the second code into a copy of the document; and
sending, by the microprocessor, the copy of the document with the embedded second code.

15. The method of claim 14, further comprising a code validator, wherein first code comprises a link to the code validator and a signed certificate and wherein the code validator:
receives a second redirect request, wherein the second redirect request is based on the link to the code validator in the first code;
validates the second redirect request, wherein second redirect request is validated based on the signed certificate in the first code; and
in response to validating the signed certificate in the first code generate the first redirect request; and
send the first redirect request to the document server.

16. The method of claim 14, wherein the interest right in the document and the changed interest right in the document are stored in a blockchain and wherein the interest right in the document is stored in a creation block in the blockchain.

17. The method of claim 16, wherein the changed interest right in the document stored in the blockchain cannot be changed again and further comprising:
creating a transaction block, wherein the transaction block comprises the changed interest right in the document; and
creating an end block, wherein the end block is a last block in the blockchain and wherein the end block indicates that the interest right cannot be changed anymore.

18. The method of claim 14, further comprising:
receiving the document and the interest right in the document, wherein the interest right in the document comprises a plurality of individual interest rights for a plurality of individual copies of the document;
in response to receiving the plurality of individual interest rights for the plurality of individual copies of the document, creating a star blockchain, wherein the star blockchain comprises a plurality of branches from a genesis block and wherein the plurality of branches are created based on the plurality of individual copies of the document.

19. The method of claim 14, further comprising:
receiving a request to verify a current interest right in the document based on the first code in the document;
sending the current interest right in the document;
receiving a request to get a new interest right in the document, wherein the new interest right is the right to use the document in a training set of an Artificial Intelligence (AI) algorithm; and
sending a response the provides the new interest right in the document.

20. A non-transient computer readable medium having stored thereon instructions that cause a processor to execute a method, the method comprising instructions to:
receive a first redirect request, wherein the first redirect request is based on a link to the document server in a first code embedded in a document;
authenticate a user, wherein the user has an interest right in the document;
receive a request to change the interest right in the document;
in response to receiving the request to change the interest right in the document, generate a second code based on the change in interest right in the document;
embedded the second code into a copy of the document; and
send the copy of the document with the embedded second code.
